(19) United States
(12) Patent Application Publication
(10) Pub. No.: US 2014/0210215 A1
(43) Pub. Date: Jul. 31, 2014

(54) AUXILIARY HYDRAULICALLY DRIVEN ALTERNATOR

(71) Applicant: NAVISTAR DEFENSE ENGINEERING, LLC, Lisle, IL (US)

(72) Inventors: Jose Antonio Marques Neto, Darien, IL (US); Ernst Alfred Duerr, Willowbrook, IL (US); William McCoy, Fort Wayne, IN (US)

(73) Assignee: Navistar Defense Engineering, LLC, Lisle, IL (US)

(21) Appl. No.: 13/752,658

(22) Filed: Jan. 29, 2013

(51) Int. Cl. H02K 7/18

(52) U.S. Cl. CPC H02K 7/1807
USPC 290/1 R

(57) ABSTRACT

An auxiliary electrical power system for a motor vehicle is described. Generally speaking, the system includes a hydraulic pump, a hydraulic motor and an auxiliary alternator. The pump is coupled to and driven by the vehicle engine mounted within the engine compartment of the vehicle, and the pump operates to pump fluid at a pressure. The hydraulic motor is operatively coupled to the hydraulic pump and turns a gear coupled to the motor. The alternator has a gear coupled by a belt to the gear of the hydraulic motor. the auxiliary alternator is positioned outside the vehicle engine compartment to conserve space for other critical engine components. Further, the hydraulic pump may be coupled to the engine power-take-off shaft. The motor gear to alternator gear ratio is about 1:4 to allow charging even at low engine idle.

### TECHNICAL FIELD

The present device and methods relate to increasing electrical power available in a vehicle. More specifically, the device and methods relate to increasing the available electrical power without interfering with engine speed or available vehicle assembly space.

### BACKGROUND

When troops in war zones first received heavily armored trucks there was a major flaw: the vehicle did not provide enough electricity to power all of the devices that needed to be plugged in. In fact, when everything electronic was connected, some vehicles did not have the requisite power to start the engine.

This provided a wake-up call for military vehicle manufacturers and for the government's program managers. Engineers immediately went to work designing new alternators and add-on power units that would meet mobile troops' rampant energy demands as more high-tech gear was being added to already cramped truck cabs and engine compartments.

The solution was to replace the vehicle's usual 200 amp alternator with twice the power—i.e., a 400-amp alternator. The power drain problem illustrates a trend seen in military vehicles over the past decade: they must be able to charge a greater array of electronic gadgets, some of which are part of million-dollar systems. In addition to personnel transport, these vehicles often function as makeshift command centers, weapon launchers, ambulances, electronic jammers, and perform other roles, all of which require loads of electricity to run an assortment of hardware.

To solve the problem of more and more portable battery-powered equipment requiring recharging, auxiliary diesel-fueled generators often are towed into combat zones. However, the military has seen dependence on towable generators as a logistics burden that also runs up fuel consumption.

A self-sufficient truck that can power all the requisite peripheral systems on its own, reliably start and maintain a charge under adverse conditions, and even simultaneously provide battery recharging capabilities for portable devices is one solution.

These and other problems are solved by the present device and system by providing auxiliary electrical power without constraining the already crowded engine compartment and without the need for increasing vehicle engine speed.

### SUMMARY

An auxiliary electrical power system for a motor vehicle is described. Generally speaking, the system includes a hydraulic pump, a hydraulic motor and an auxiliary alternator. The pump is coupled to and driven by the vehicle engine mounted within the engine compartment of the vehicle, and the pump operates to pump fluid at a pressure. The hydraulic motor is operatively coupled to the hydraulic pump and turns a gear coupled to the motor. The alternator has a gear coupled by a belt to the gear of the hydraulic motor.

In an embodiment, an electrical power system for mounting in a vehicle having an engine positioned within an engine compartment, is disclosed. The system comprises a hydraulic pump coupled to and driven by a power-take-off of the engine, wherein the pump operates to pump fluid at a pressure in response, a hydraulic motor operatively coupled to the hydraulic pump, wherein the motor then turns a gear coupled to the motor; and an alternator having a gear coupled by a belt to the gear of the hydraulic motor, wherein the alternator is positioned outside the engine compartment.

Additional embodiments and features of the system can be understood from the appended drawings and the detailed description below.

### BRIEF DESCRIPTION OF THE DRAWINGS

FIG. 1 is a schematic illustrating an embodiment of the present auxiliary electrical power system;

FIG. 2 is a side view of the motor gear and alternator gear test bench;

FIG. 3 is a chart illustrating a relationship between engine speed and alternator speed in the auxiliary system;

FIG. 4 is a schematic of a vehicle engine compartment and an area behind the vehicle cabin where an embodiment of the present system is positioned; and

FIG. 5 is a peripheral view of a hydraulic pump used in the present system coupled to a vehicle engine power-take-off shaft.

### DETAILED DESCRIPTION

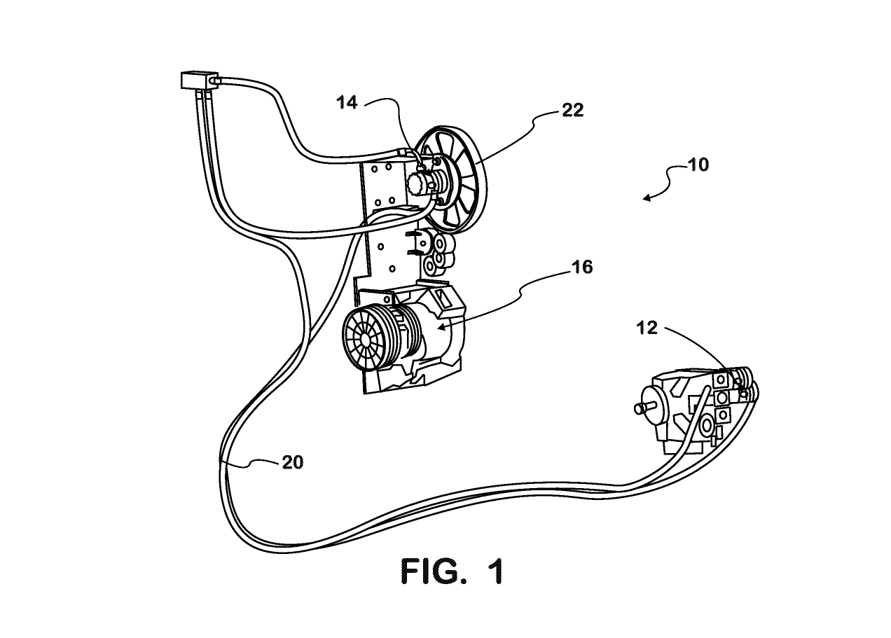

With reference to FIGS. 1-5, an embodiment of the auxiliary electric power system can be seen. The system is generally indicated in the appended drawings by the numeral 10, and system components are identified consistently throughout the drawing figures.

FIG. 1 illustrates an embodiment of system 10 comprising a hydraulic pump 12, a hydraulic motor 14, and an auxiliary alternator 16. The hydraulic pump 12 is fluidly coupled through hoses 20 (i.e., one hose is for delivery of fluid at pressure and the other is a return line) to the hydraulic motor 14. A large pulley gear 22 is connected to and driven by the hydraulic motor 14. The pulley gear 22 is coupled via belt 24 to a gear 26 on the auxiliary alternator 16.

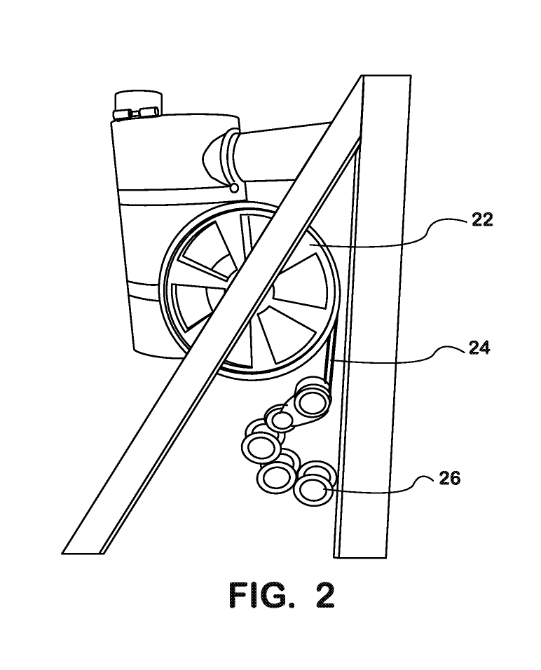

In FIG. 2, a gear ratio of 1:4 (alternator gear to motor gear) is illustrated on a test bench. The ratio allows the alternator 16 to be fully functional even at low idle engine speed. However, gear ratios in the range of from about 2:1 to about 1:6 may be suitable for alternate embodiments.

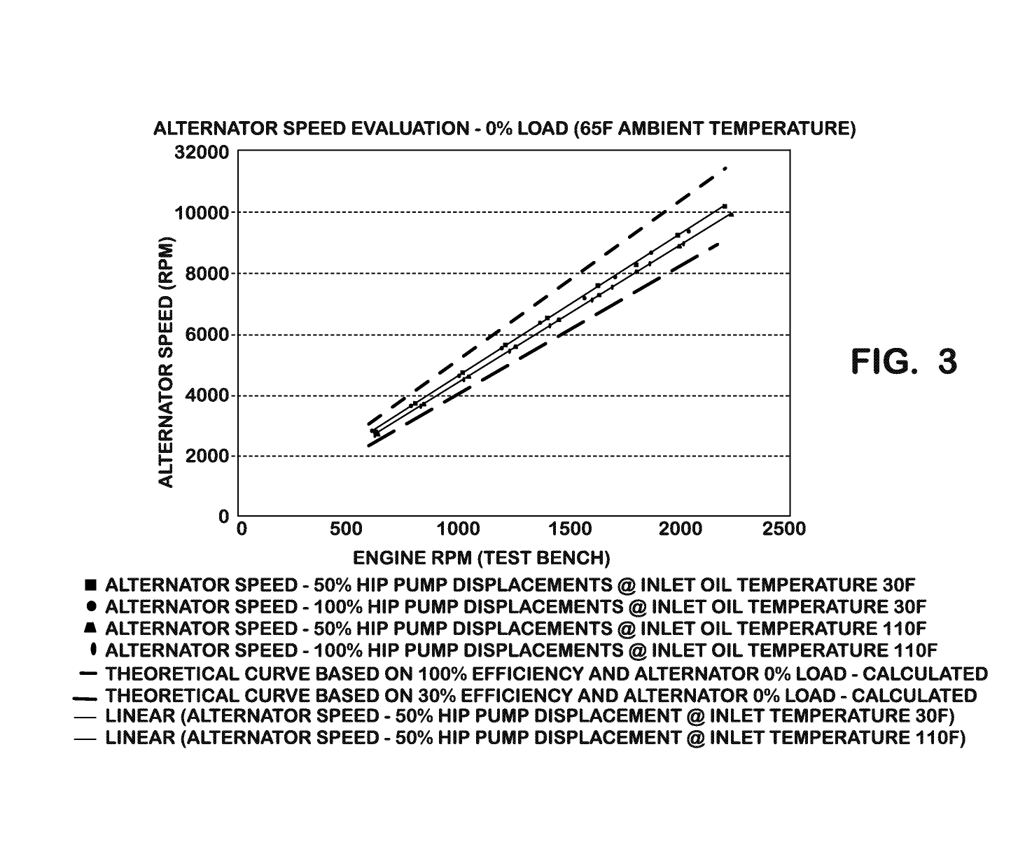

FIG. 3 illustrates the alternator speed to engine speed as a result of the illustrated gear ratio on the test bench of FIG. 2. Two theoretical lines are shown to provide reference, with one line being based on 100% efficiency and the other based on 80% efficiency. Actual speeds are plotted for 50% and 100% pump displacements and at oil temperatures of 80° and 110° F. Charging of the alternator is expected at a 15-20% reduction.

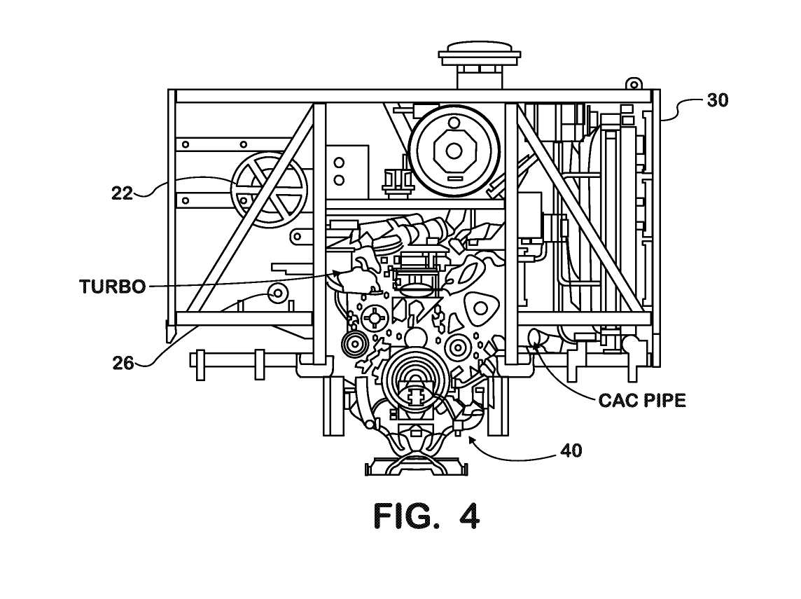

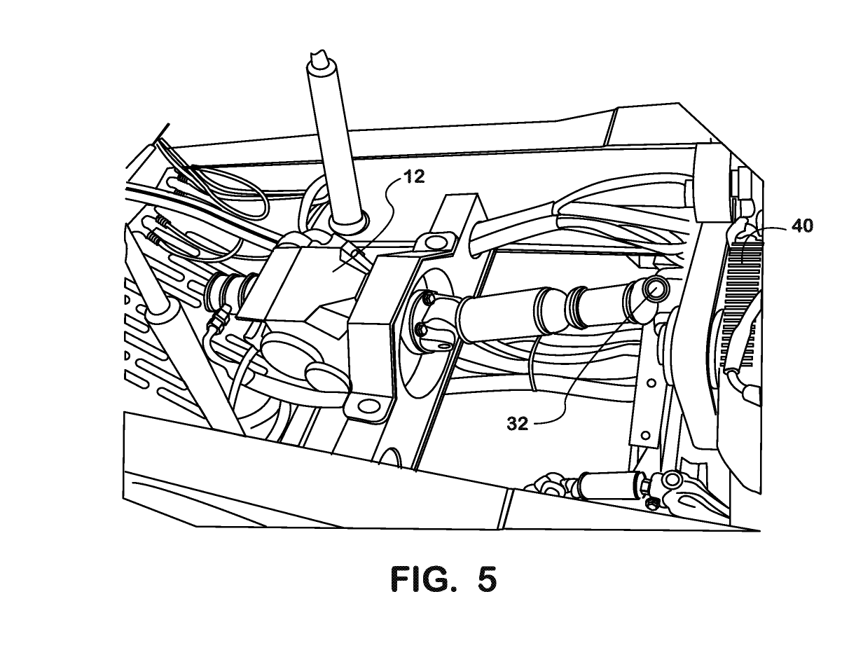

A key to the present system 10 is the ability to position the alternator 16 almost anywhere on the vehicle. FIG. 4 illustrates a mounting of the alternator 16 behind the vehicle passenger cabin wall 30. The hydraulic pump 12 is directly coupled to the engine power-take-off shaft 32 (FIG. 5). The hoses 20 then connect the pump 12 to the hydraulic motor 14, which allows the fluid pressure generated at the pump 12 to drive the motor 14. A pulley gear 22 is mounted on the motor shaft 23 and is coupled to the alternator gear 26 by a gear belt 24.

In use, as the vehicle engine 40 runs, the hydraulic pump 12 is driven by the engine PTO 32 to move fluid at a pressure through hoses 20. The fluid drives the hydraulic motor 14 at a relative speed, which turns pulley gear 22. The pulley gear 22 operates the alternator gear 26 via connection through gear belt 24. Due to the 1:4 gear ratio (alternator:motor), the alternator gear 26 turns at a greater speed thereby charging at low engine idle.

What is claimed is:

1. An auxiliary electrical power system for a motor vehicle, the system comprising:
a hydraulic pump coupled to and driven by an engine mounted within an engine compartment of the vehicle, the pump operating to pump fluid at a pressure;
a hydraulic motor operatively coupled to the hydraulic pump, wherein the motor then turns a gear coupled to the motor; and
an alternator having a gear coupled by a belt to the gear of the hydraulic motor.

2. The auxiliary electrical power system of claim 1, wherein the alternator is positioned outside the vehicle engine compartment.

3. The auxiliary electrical power system of claim 1, wherein the hydraulic pump is coupled to the engine power-take-off.

4. The auxiliary electrical power system of claim 1, wherein the motor gear to alternator gear ratio is in the range of from about 2:1 to about 1:6.

5. The auxiliary electrical power system of claim 4, wherein the motor gear to alternator gear ratio is about 1:4.

6. The auxiliary electrical power system of claim 1, wherein the alternator is charged even at low idle engine speed.

7. An electrical power system for mounting in a vehicle having an engine positioned within an engine compartment, the system comprising:
a hydraulic pump coupled to and driven by a power-take-off of the engine, wherein the pump operates to pump fluid at a pressure in response;
a hydraulic motor operatively coupled to the hydraulic pump, wherein the motor then turns a gear coupled to the motor; and
an alternator having a gear coupled by a belt to the gear of the hydraulic motor, wherein the alternator is positioned outside the engine compartment.

8. The electrical power system of claim 7, wherein the alternator is positioned on the back of the vehicle cabin.

9. The electrical power system of claim 7, wherein the hydraulic pump is coupled to the engine power-take-off.

10. The electrical power system of claim 7, wherein the motor gear to alternator gear ratio is in the range of from about 2:1 to about 1:6.

11. The electrical power system of claim 10, wherein the motor gear to alternator gear ratio is about 1:4.

12. The electrical power system of claim 7, wherein the alternator is charged even at low idle engine speed.
